(19) United States
(12) Patent Application Publication
(10) Pub. No.: US 2006/0174335 A1
(43) Pub. Date: Aug. 3, 2006

(54) Systems and methods of establishment of secure, trusted dynamic environments and facilitation of secured communication exchange networks

(75) Inventor: Don R Jorgenson, Fort Collins, CO (US)

Correspondence Address: SANTANGELO LAW OFFICES, P.C., 125 SOUTH HOWES, THIRD FLOOR, FORT COLLINS, CO, 80521, US

(73) Assignee: DYNEXUS, INC., FORT COLLINS, CO (US)

(21) Appl. No.: 10/521,803

(22) PCT Filed: Oct. 25, 2004
(86) PCT No.: PCT/US04/35457

§ 371 Date: Jan. 21, 2005

Related U.S. Application Data
(60) Provisional application No. 60/481,551, filed on Oct. 24, 2003.

(51) Int. Cl. H04L 9/32

(52) U.S. Cl. 726/10

(57) ABSTRACT

Systems and methods of establishment of secure, trusted dynamic environment and facilitation of secured communication exchange networks may include a community (1) having an intermediary (2) with a contractual link (4) to a plurality of members (3). An agreement between an applicant and an intermediary may be created which may obligate the applicant to a set of community rules. Members (3) of a community (1) may submit inquiry requests for communication with each other and can obtain certificates of compatibility for such communications.

### FIELD OF THE INVENTION

The present invention relates generally to data management and, to a system and method for managing the exchange of data and related services between a plurality of entities subject to community-wide rules governing their interaction(s). More specifically, the present invention relates to systems and methods of establishment of secure, trusted dynamic environments and facilitation of secured communication exchange networks.

### BACKGROUND

Many emerging business imperatives, particularly those driven by privacy and security concerns, can require tightly controlled partner interaction frameworks that could be binding across an entire business community. Some of these imperatives will derive from the mandated provisions of federal and state laws such as the Gramm-Leach-Bliley Act and the Health Insurance Portability and Accountability Act (“HIPAA”), both hereby incorporated by reference. Compliance with the HIPAA transaction, privacy and security regulations presents especially difficult problems for which existing solutions are very expensive.

For example, the HIPAA regulations may include provisions that mandate that each health care provider, health plan or healthcare clearinghouse (collectively “Covered Entities”) must enter into legally-binding agreements with any business associate or trading partner that performs a function, activity or the like on their behalf and with whom they exchange Protected Health Information. In addition, Covered Entities may be required to certify their privacy and security regulation compliance and perhaps even to require such certification from all Covered Entities with whom they exchange Protected Health Information.

A general problem may be represented as the requirement to establish any k of n(n−1)/2 potential links (e.g. perhaps 300 out of 2 trillion potential links) and where the k links may be dynamic. A “link” can correspond to a business relationship subject to legal terms and conditions and the nodes terminating a link may each have a set of unique policies (commitments, requirements, and constraints) that may be compatible in order for certain interactions between the node entities can be allowed. When n is large and each of the k links potentially may be established between random nodes, the time required in situations where legally-binding agreements should be executed between parties geographically separated before document exchange or other entity interaction can occur can have a detrimental impact on patient care or other business matters. Under these circumstances, representatives of each entity must negotiate and execute an appropriate and mutually acceptable agreement on an ongoing basis—this process may require substantial time, additional personnel and may even require additional outside legal services. It is burdensome both financially and perhaps on limited, overworked personnel.

In effect, a vendor (healthcare provider) may enter into a separate agreement with each customer (patient) and upon the request of an originating node, the policies of each participating node for a potential link should be compared upon request of a participating end point to determine if they meet the requirements of each participating node.

U.S. Pat. No. 6,926,675 to Meltzer et al. describes participant services in a network of customers, suppliers, and other trading partners that exchange machine readable documents. Business transactions may be carried out in an electronic commerce system in a way in which paper based businesses operate.

U.S. Pat. Publication No. 2001/004727276 to Eisenhart describes technology exchange and collaboration on a network system such as the Internet. Specifically, this system facilitates collaboration between a technology Supplier and Buyer of a technology asset.

U.S. Pat. Publication No. 2002/0103661 to Albazz provides a system and method for representing business policies and procedures and governing the conduct of business activities using a business rule book.

In the past, it has not been disclosed to provide an establishment of a secure, trusted environment having a community rule set established and wherein each member of a community enters into an agreement at least substantially based upon the community set of rules which effectively contractually binds the member to each other member of the community. This agreement may be established prior to any interactions with other members and a community may help facilitate proper interactions between the members.

### DISCLOSURE OF THE INVENTION

The present invention solves many or all of the foregoing problems by providing a system and method that may require only one agreement per member. It may provide a framework that may eliminate the need to enter into separate agreements between each set of interacting members. In effect, it may be as if each member has entered into a contractual agreement with every other member.

Accordingly, it is an object of the present invention to provide a secured environment that establishes a community having community rules to which each member is contractually bound.

It is another object of the invention to provide a secure, trusted environment that may allow members of a community to communicate between each other while being assured that each member is bound by a set of community rules.

It is yet another object of the invention to provide a secured environment that allows members of a community to exchange information, such as health care information, financial information, personal identification information and the like, between each other while being assured that each member is bound by a set of community rules.

It is another object of the invention to provide a secured environment where a member may specify additional requirements for interaction with other members.

It is yet another object of the invention to provide a secured environment that allows members to submit a query for communication with another member and perhaps even receive a certification of compatibility between members.

It is yet still another embodiment of the invention to provide a secure, trusted environment for communication exchange between members wherein a community is based upon compliance with HIPAA. It is therefore a goal of this object to provide a community which facilitates the exchange of protected health information between members.

### BRIEF DESCRIPTION OF THE DRAWINGS

FIG. 1 is a block diagram of a community having members and an intermediary linking the members according to an embodiment of the invention.

FIG. 2 is a block diagram of various embodiments of the present invention showing a management system, system functional modules, software framework and a hardware platform.

FIG. 3 is a block diagram of a group of actions/elements that may be presented in various embodiments of the invention.

FIG. 4 is a block diagram of a group of actions/element that may be presented in various embodiments of the invention.

FIG. 5 is a block diagram of alternative actions/elements that may be presented in an embodiment of the invention.

### MODES(S) FOR CARRYING OUT THE INVENTION

The present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

The present invention may include, in embodiments, a computer accessible and implemented method to establish secure, trusted dynamic environments. A computer accessible secure, trusted dynamic environment may establish and maintain a community legal framework that all community members agree to as being necessary to enable proper member interactions. In embodiments, an enrollment or even a registration process may serve to bind a new member to the community by contract.

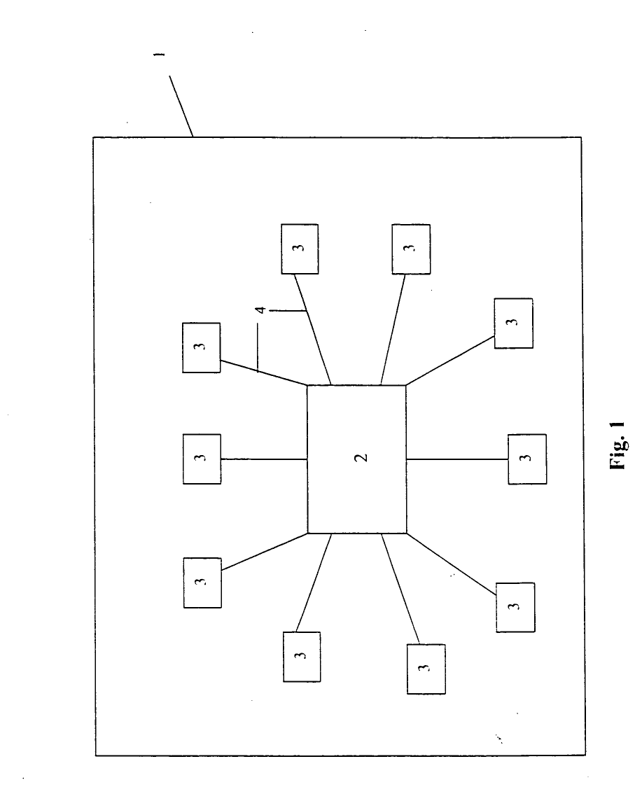

It may be important, in some embodiments, to establish a legal authority of an intermediary and perhaps even an ability to enforce community rules for member interactions. As can be seen in FIG. 1, a community (1) may provide an intermediary (2) having a contractual link (4) with a plurality of members (3). A legal entity, such as a trust clearinghouse may be formed. A trust clearinghouse may establish and embody a framework in which contractual relationships, whether implicit (reliance of policy statements or certifications) or even explicit, can be established or terminated under control of the interacting parties. As such, in embodiments, an agreement may be generated between an intermediary and an application having terms which may be explicit or even implicit. The invention may allow legitimate interaction between members perhaps without further legal concerns and may facilitate proper interactions between community members that are consistent with the rules of the community and perhaps even any additional criteria defined by the interacting members. In embodiments the present application may provide granting an intermediary to enforce an agreement(s) and may even provide an enforcer of agreements between members.

Instead of requiring a separate agreement between each entity involved in an interaction, it may only be necessary to become a member of the community with confirmed membership in the community being sufficient to permit interactions relying on the rules of the community.

The invention may include, in certain embodiments, an automated means for establishing a community that may effectively subject the community to constraints that precondition or limit the nature and extent of legitimate interactions with other community members. In embodiments, a community may include an intermediary, such as a trust clearinghouse, which may be a legal entity and perhaps even a physical computer technology entity. The present invention may provide an intermediary between an applicant and existing members of a community or perhaps even an intermediary between existing members. An intermediary legal entity, such as a trust clearinghouse entity, with a network embodiment as a computer system may coordinate, manage and even administer a community. For example, a management entity of a community, such as an intermediary, may manage at least one community interface and a community. A community interface may be any kind of arrangement of a communication between an intermediary and another entity. A community interface may include a website or the like that may be accessible by a network, such as the Internet, Ethernet and the like.

Members may include member nodal entities which may be the nodes providing a link that may each have a set of unique policies (commitments, requirements, constraints and the like) that should be compatible in order for certain interactions between the members, such as node entities, to be allowed. A community of members that may be subject to community-wide rules and can interact directly between each other may be subject to legally binding agreements.

An intermediary, such as a intermediary nodal entity, or even a trust clearinghouse may serve a role of an intermediary that may be a vehicle which facilitates the binding of a nodal entity, members or even a new member applicant to the rules of the community, such as a charter, and, thereby, the acceptance of community constraints. It may also support establishment and management of flexible interaction between members such as nodal entitles, based on the compatibility of their individual policies. Upon a request of an originating node, policies of each participating node for a potential link can be compared upon request of a participating end point to determine if they meet the requirements of each participating node. It may automatically evaluate compatibility and may even validate the status of interacting members.

A charter may establish a minimum common denominator terms and conditions that may be necessary and perhaps even sufficient to achieve an intended purpose. An example of an intended purpose may be HIPAA regulatory compliance. In embodiments, the present invention may provide a community rule set based upon a minimum standard. Community rules may be determined from a minimum standard which may include any set of rules that may be desirable including but certainly not limited to regulated acts, state laws, federal laws, foreign laws, health care regulations, financial information regulations, personal identification regulations and the like. In some embodiments, it may be desirable to determine community rules based upon at least one health care regulation. For example, a minimum standard may include the Health Insurance Portability and Accountability Act and a community rule set acts to comply with the Health Insurance Portability and Accountability Act. In other embodiments, it may be desirable to determine community rules based upon at least one financial information regulation. For example, a minimum standard may include the Gramm-Leach-Bliley Act and a community rule set may act to comply with the Gramm-Leach-Bliley Act. Each of the specific acts stated herein are meant to provide examples of some of the embodiments of the present invention. The invention is not meant to be limited to such example and as intended to include any set of standards that may act to provide a basis for a community rule set. Some examples of community rules may include, but are certainly not limited to, confidentiality, encryption/decryption procedures, identification verification, minimum communication requirements, access to information, communication documentation, information transfer procedures and the like.

The present invention may support sub-community rules in cases where circumstances of a member may require interaction constraints either more or less restrictive than the basic community rules, a member may elect to conform to sub-community rules that preempt the basic community rules. A minimum standard, as previously discussed, may include the minimum basis for establishment of a community rule set. Other rules, standards, requirements, or the like may be added to the minimum standards of a community, or in embodiments, to an individual member agreement.

A charter may be a document that defines the purpose of the community together with the rights, responsibilities and constraints of the members. A charter may be based upon standards as discussed above. A community may be a group of nodal entities defined by and bound by the provisions of the community charter. Constraints may include limitations or conditions on entity behavior acceded to by a member through representations, commitments, warranties with respect to the intermediary entity and other members. An intermediary entity may be an entity that facilitates the establishment, maintenance and functioning of the community. It may use an intermediary legal entity with a network embodiment as a computer system. A member may be a nodal entity that is currently enrolled in the community. A member, such as a nodal entity, may be an autonomous nodal entity which may be a person, individual, organization, computer system, machine, company, corporation, entity or other entities capable of interaction with other members. In some embodiments, an applicant or a member may be a consultant, lab, clinic, information technology service, hospital, billing service, collection service, specialist, accountant, health maintenance organization, pharmacy, lawyer, transcriptionist, insurer, group health plan, Medicare, physician or the like.

An intermediary may possess legal rights and responsibilities according to the terms of a charter. Interaction between members may include, but is not limited to, data and document exchange, transactions and the provision of services.

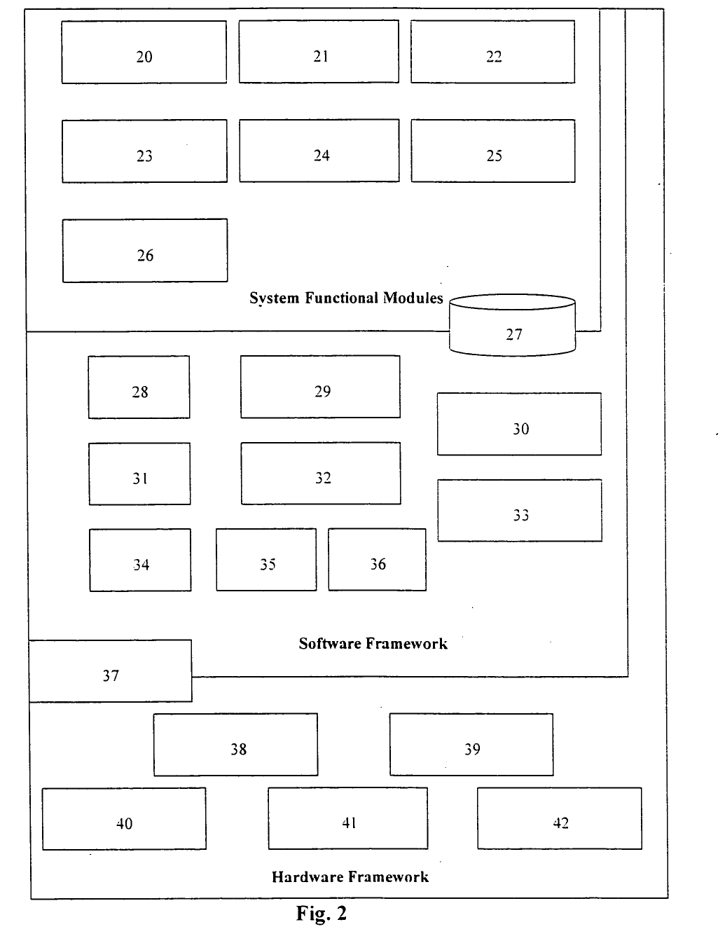

A system platform may include a representative hardware and software platform that may facilitate the implementation of the invention as represented in the block diagram of FIG. 2. A platform could be configured in capacity and reliability as required to support a community. A system should also be appropriately protected from non-authorized use, such as Internet attacks, and should apply the best available practices for a robust and reliable host for the invention. This may include implementing protection of a community interface against non-authorized use.

In embodiments, the present invention may provide a community which includes hardware and software. Software may be developed to encompass the various embodiments of the present invention. Various subroutines may be implemented to provide the various elements and steps as described herein. System functional modules may include, but is not limited to, profile management (20), certificate generator (21), certificate validation (22), agreement generator (23), certificate revocation (24), compatibility engine (25), message handler (26) and the like. A database (27) or even a plurality of databases may be provided in embodiments of the present invention. A software framework may include, but is not limited to, OS (28), HTTP server (29), secure file storage (30), J2EE (31), smart token support (32), encryption/decryption (33), SOAP (34), XML (35), PKI (36) and the like. A network interface (37) may also be provided. A hardware platform may include, but is not limited to I/O (38), mass storage (39), ROM (40), CPU (41), RAM (42) and the like.

A system may be accessed in a variety of ways. In embodiments, the present invention may include providing at least one electronically accessible community interface. Initial access to the system could be through a pedestrian web site, such as a pedestrian page which may be accessible by anyone, and may even be accessible through the Internet. A pedestrian page may provide information regarding a scope of the community or communities, rules of each community including requirements for membership, a means for enrolling and the like.

An enrollment process may begin with a collection of prospective member profile data that may be necessary to facilitate membership agreement generation and relationship management. Enrollment forms, such as a new member application, may be presented on a general interface of a community interface such as through the applicant's web browser or other suitable interface. At least one applicant may select a new member application where a system may then prompt an applicant to enter applicant identification information. After a new member application may be completed a system may accept the completed new membership application with the applicant identification information.

In embodiments, applicant identification information may include name, address, desired commitments, requirements of other member parameters and other information. Collected data from the applicant may include descriptions of a role an applicant proposes to play within a community, commitments the applicant may be willing to make to a community, any requirements an applicant has related to interactions with other members and the like.

A system may then process a new membership application having applicant identification information with a new membership application processor. Processing of a new membership application may include the use of software and may even include storing applicant identification information to a database.

Information, together with a community rule set, such as a charter, can be used by an agreement generator to generate a membership agreement that may define representations and obligations of the parties. An agreement generator may create and populate a database file that may hold member's interaction requirements, commitments, agreements, and other criteria in a form usable by a compatibility engine.

An agreement may be substantially based upon at least the community rules. An agreement may be prepared to establish a commitment for another member's benefit and may even be effectively legally-binding on the applicant, an intermediary entity and other community members. A system may prompt an applicant to execute a generated membership agreement which may then be executed, either by conventional or digital signature, perhaps by both the applicant and the intermediary entity. In embodiments, the present invention may provide an agreement execution certifier which certifies execution of an agreement to ensure that proper contractual obligations are created. In a conventional aspect, an original signature document may be signed, perhaps in front of a witness or even a notary, and sent to an intermediary for verification. In a digital aspect, a digital signature program or a digital signature element may be used.

A system may contractually obligate an applicant and even each existing member of a community to a set of community rules for the benefit of the members. In embodiments, a contractual link between an applicant and a community rule set may be established which may provide a commitment for another community member's benefit. This may effectively obligate an applicant, each existing member and perhaps even future members of a community to the community rules.

Upon successful enrollment, a system may permit an applicant access to a membership area of a community. A membership area may be accessed through a member accessible interface for use by existing members. In embodiments, access to a membership area may provide for facilitation of private information exchange. An applicant could be issued a member digital certificate for authorized access to membership areas. For example, a member digital certificate may be presented and validated to gain access to a members only web site for the community.

In embodiments, an applicant may be prompted by a system to enter applicant specific community rule criteria. This may be presented in a new member application, at any time perhaps even during the duration of the affiliation of a member with a community. Applicant specific community rule criteria may include any additional requirement that an applicant may have for communication with another member. This may be in addition to a community rule set in certain embodiments. Accordingly, in embodiments, an agreement generated by an agreement generator may be based upon community rules and applicant specific community rule criteria. An agreement, whether based upon applicant specific community rule criteria or not, may limit member interactions. In embodiments, interactions between member may be limited so that they may be in compliance with the community rules and perhaps even with applicant specific community rule criteria.

Any member representative with suitable authorization may conduct routine maintenance of a profile through any available member interface. Community rules, such as a charter, may provide that certain profile elements that affect the member's legal obligations may be changed by declaration and notification. In the event the member wishes to change commitments, requirements, or other profile elements that affect its interactions with community members or the intermediary entity, the changes should be properly approved and acknowledged by a member representative having authorization to legally commit the member. Accordingly, in various embodiments, the present invention may provide an interface for members to submit changes to legal obligations, processing submitted changes to the member obligations, a membership information update interface, a membership obligations change approval element and perhaps even a membership obligations change denial element.

One of the important features that may be included in the present invention may be a communication facilitator between the members which may help facilitate proper communication between the members. An intermediary may be used for facilitating these communications. By facilitating it is meant to be understood that a system and perhaps an intermediary may provide a framework for each member's use so that members can communicate with each other being assured that the communications comply with the community rules and possibly even comply with any individual member specific community rule criteria.

In embodiments, the present invention may provide a secure communication exchange facilitator for facilitating a securely exchanged communication between a querying member and a target member. For example, a secure private information exchange facilitator may facilitate private information to be communicated between a querying member and a target member. A communication should be protected from unauthorized use and a system may provide an information encryption element and an information decryption element which may encrypt and decrypt a communication such as private information.

In embodiments, it may be desirable to verify identification and even authorization of another member prior to communication between members. When one member wishes to check the membership status of another member, a member, a querying member may access an inquiry interface, such as a communication inquiry interface or even a private information exchange inquiry interface, perhaps through a membership area of a community. A member may query a system to assess a target member's membership status, commitment/requirement compatibility between themselves and the target, and perhaps even review a target member's commitments and requirements. For example, an inquiry can be submitted by a communication source such as a Web browser, interface, paper submission, SOAP messages or other suitable interface and may be capable of manually collecting and submitting query data. An automated means such as SOAP messages generated by a server may be employed to submit queries and receive responses. In either case, a message, which may be encrypted, may be sent to a communication inquiry processor when it may be received, decrypted and otherwise processed by a message handler and then forwarded to a member compatibility processor such as a compatibility engine.

After an inquiry request has been submitted, a system may accept an inquiry from a query member and may even process an inquiry. This may include storing an inquiry to a database and may even provide a system that may check compatibility of a querying member with a target member in a compatibility engine. A compatibility engine may compare and evaluate the level of compatibility between a querying member and a target member. Depending on the rules of the community and perhaps even additional criteria defined by the members, an algorithm may be employed and may range from simple and deterministic comparison of member commitments and requirements to a complex, even fuzzy correlation of member characteristics. In embodiments, a compatibility check may include checking compatibility between a querying membership agreement and a target membership agreement. At the time a member may submit an inquiry, a system may allow a querying member to specify additional criteria for a compatibility check. This may include, in embodiments, an additional criteria specification element which may result in checking compatibility between a querying member agreement, additional criteria, and a target member agreement. A member compatibility processor such as a compatibility engine may utilize an algorithm such as defined in a software or even a subroutine of software to perform the compatibility check.

A compatibility engine may generate a report based upon a compatibility check. A report from a compatibility engine may be sent or even forwarded to a certificate generator which may format and encapsulate the report, digitally sign it with perhaps a digital signature element, and may even send the resulting certificate to a querying member such as by issuing a certificate of compatibility. A certification generator may be responsive to a compatibility engine and report. A querying member can then assess which interactions with a target member may be permitted. For example, a certificate of compatibility may allow for private information exchange.

A certificate generator may be responsible for generating digital credentials and authoritative representations that may be required to establish and maintain the community. Certificate validation and revocation may support the maintenance of system and community integrity.

Different types of communication may be facilitated between members. A communication may be any kind of knowledge, information and the like. A communication may be communicated in compliance with the community rules. For example, but not limited to, a communication may include health information exchange, financial information exchange, personal identification information exchange, document exchange, a business transaction, provision of services and the like.

In embodiments, the present invention may provide a communication inquiry denial element responsive to a compatibility engine which may deny an inquiry from a querying member for communication with a target member based upon a compatibility check of a querying member and a target member. In other embodiments, the present invention may provide a communication inquiry grant element responsive to a compatibility engine which may grant an inquiry from a querying member for communication with a target member based upon a compatibility check of the querying member and the target member.

In yet other embodiments of the present invention a certificate of compliance may be issued. A certificate of compliance may be a document that can certify that a member or members are complying with the community rules.

A system database may provide a persistent storage of system information including member profile data certificates, current certificate and certificate revocation lists, archived agreements. Further, in embodiments, a database may store additional information from a community including but not limited to member interactions, member requirements, member commitments, member updates, certificates, archived agreements, member agreements, current certificates, a certificate revocation list and the like.

The present invention may provide, in embodiments, a certificate validation element which can be used to validate a certificate of compatibility or even a certificate of compliance. A certificate revocation element may be provided which can be used to revoke a certificate of compatibility or even a certificate of compliance.

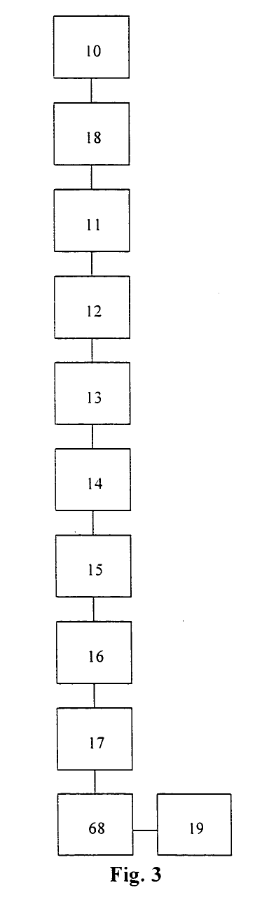

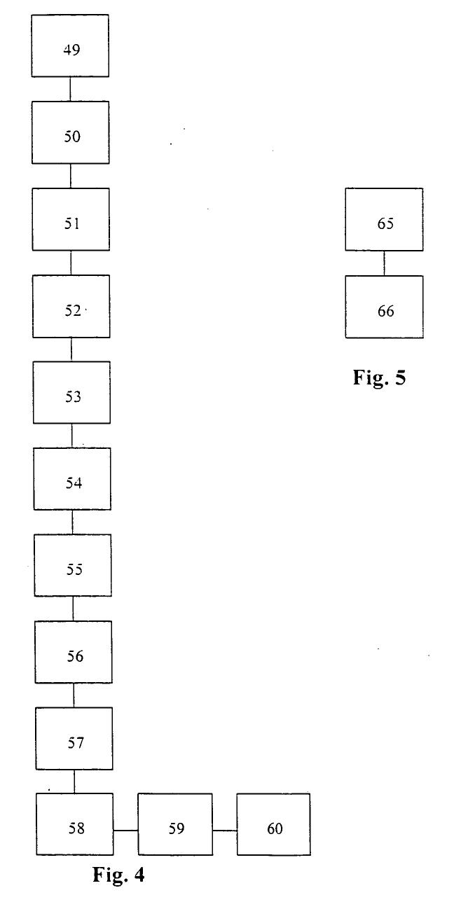

FIGS. 3, 4 and 5 include some of the various embodiments of the present invention as herein disclosed and discussed. A system may include determining community rules (10), providing a general interface (18) which may have a new membership application (11), prompting an applicant to enter applicant identification information (12), accepting a completed application (13), processing an application with a new member processor (14), generating an agreement with an agreement generator (15), prompting an applicant to execute an agreement (16), certifying execution of an agreement with an agreement execution certifier (17), storing an agreement to a database (68) and permitting access to a membership area of a community (19). A system may include a membership area (49) which may provide an inquiry interface (50) such as a communication inquiry interface, accepting an inquiry (51), processing an inquiry with a inquiry processor (52), checking compatibility with a member compatibility processor (53), providing a communication inquiry grant and/or denial element (54), generating a report based on a compatibility check (55), sending a report to a certificate generator (56), issuing a certificate of compatibility (57), facilitating communications between members such as with a communication facilitator (58), providing a encryption and/or decryption element for any communications and perhaps even any inquiry requests (59) and providing a validation and/or revocation element to validate or perhaps even revoke certificates (60). A membership information update interface (65) may be provided within a system which may include a member change approval and/or denial element (66). These drawings are meant to help with understanding of the present invention and are not meant to be limited to the number of steps, elements that may be presented in specific embodiments of the invention.

As can be easily understood from the foregoing, the basic concepts of the present invention may be embodied in a variety of ways. It involves both techniques for securing and community management techniques as well as devices to accomplish the appropriate secured community. In this application, the securing and community management techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon in any subsequent patent application. It should be understood that such language changes and broader or more detailed claiming may be accomplished at a later date. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “certification” should be understood to encompass disclosure of the act of “certifying”—whether explicitly discussed or not—and, conversely, were there effectively disclosure of the act of “certifying”, such a disclosure should be understood to encompass disclosure of a “certification” and even a “means for certifying” Such changes and alternative terms are to be understood to be explicitly included in the description.

Any acts of law, statutes, regulations, or rules mentioned in this application for patent; or patents, publications, or other references mentioned in this application for patent are hereby incorporated by reference. The priority case, U.S. Provisional Patent Application No. 60/481,551, filed Oct. 24, 2003, is hereby incorporated by reference including any figures or attachments. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the below chart or any other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

U.S. PATENT AND PATENT PUBLICATION DOCUMENTS

| DOCUMENT | | | | SUB- | FILING |
|---|---|---|---|---|---|
| NO | DATE | NAME | CLASS | CLASS | DATE |
| 5,958,050 | 09/28/1999 | Griffin | 713 | 200 | 12/26/1996 |
| 5,987,423 | 11/16/1999 | Arnold | 705 | 14 | 03/28/1997 |
| 5,692,206 | 11/25/1997 | Shirley | 395 | 793 | 11/30/1994 |
| 6,067,531 | 05/23/2000 | Hoyt | 705 | 35 | 07/21/1998 |
| 6,226,675 | 05/01/2001 | Meltzer | 709 | 223 | 10/16/1998 |
| 6,236,984 | 05/22/2001 | Owens | 707 | 1 | 11/26/1997 |
| 6,256,734 | 07/03/2001 | Blaze | 713 | 157 | 10/08/1999 |
| 2001/0047276 | 11/29/2001 | Eisen- | 705 | 1 | 03/27/2001 |
| | | hart | | | |
| 2002/0087859 | 07/04/2002 | Weeks | 713 | 156 | 05/21/2001 |
| 2002/0103661 | 08/01/2002 | Albazz | 705 | 1 | 10/30/2001 |
| 2003/0154137 | 08/14/2003 | Carroll | 705 | 26 | 02/13/2002 |

OTHER DOCUMENTS (Including Author, Title, Date, Pertinent Pages, Etc.)
US Provisional Application Number 60/481,551, filed Oct. 24, 2003

Thus, the applicant(s) should be understood to have support to claim and make a statement of invention to at least: i) each of the establishment of secured environment devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, and xii) each potentially dependent claim or concept as a dependency on each and every one of the independent claims or concepts presented.

In addition and as to computer aspects and each aspect amenable to programming or other electronic automation, the applicant(s) should be understood to have support to claim and make a statement of invention to at least: xii) processes performed with the aid of or on a computer as described throughout the above discussion, xiv) a programmable apparatus as described throughout the above discussion, xv) a computer readable memory encoded with data to direct a computer comprising means or elements which function as described throughout the above discussion, xvi) a computer configured as herein disclosed and described, xvii) individual or combined subroutines and programs as herein disclosed and described, xviii) the related methods disclosed and described, xix) similar, equivalent, and even implicit variations of each of these systems and methods, xx) those alternative designs which accomplish each of the functions shown as are disclosed and described. xxi) those alternative designs and methods which accomplish each of the functions shown as are implicit to accomplish that which is disclosed and described, xxii) each feature, component, and step shown as separate and independent inventions, and xxiii) the various combinations and permutations of each of the above.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 U.S.C. § 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1-212. (canceled)

213. Method for creating and managing multilateral contractual relationships among contracting parties under a privacy standard, said contracting parties comprising (1) “covered entities” receiving data of customers and creating, recording, using, and disclosing private data of such customers in the ordinary course of business, and (2) “business associates” requiring the use of said private data, said method comprising the steps of:
(a) assigning digital identities to the contracting parties;
(b) providing a multilateral Master Business Associate Contract (MBAC) template having non-negotiable terms requiring observation of said privacy standard with respect to said private data of a customer;
(c) providing an electronic interface accessible to said digital identities to facilitate negotiating and entering binding multilateral contractual agreements among at least one of said covered entities and a plurality of said business associates pursuant to the terms of said MBAC template; and
(d) storing said multilateral contractual agreements in an MBAC database.

214. The method according to claim 213, including the additional step of providing self-certification provisions in said MBAC for contracting parties to certify adherence to said privacy standard as self-certified covered entities or as self-certified business associates.

215. The method according to claim 213, wherein said electronic interface includes interactive means for negotiating additional terms with respect to use or disclosure of said private data.

216. Method for creating and managing multilateral contractual relationships among contracting parties under a privacy standard, said contracting parties comprising (1) “covered entities” receiving data of customers and creating, recording, using, and disclosing private data of such customers in the ordinary course of business, and (2) “business associates” requiring the use of said private data, said method comprising the steps of:
(a) assigning digital identities to the contracting parties;
(b) providing a multilateral Master Business Associate Contract (MBAC) template having non-negotiable terms requiring observation of said privacy standard with respect to said private data of a customer;
(c) providing self-certification procedures for contracting parties to certify adherence to said privacy standard as self-certified covered entities or as self-certified business associates;
(d) providing an electronic interface accessible to said digital identities to facilitate negotiating and entering binding multilateral contractual agreements among at least one of said self-certified covered entities and a plurality of said self-certified business associates pursuant to the terms of said MBAC template; and (e) storing said multilateral contractual agreements in an MBAC database.

217. The method according to claim 216, wherein said self-certification procedures comprise the additional steps of: providing a self-certification standard affidavit template for self-certification by electronic signature; and storing affidavits corresponding to said template in a separate self-certification database.

218. The method according to claim 216, wherein said self-certification procedures comprise warranty clauses in said MBAC.

219. The method according to claim 216, wherein said electronic interface includes interactive means for negotiating said additional terms with respect to use or disclosure of said private data.

220. The method according to claim 216, wherein said interactive means includes means for a covered entity to offer and for a business associate to accept said non-negotiable terms in the MBAC.

221. The method according to claim 216 including the additional step of: accessing a selected multilateral contractual agreement in said MBAC database for permission to disclose selected private data to a selected self-certified business associate.

222. The method according to claim 216, wherein said electronic interface comprises the internet.

223. Method for creating and managing multilateral contractual relationships among contracting parties under a privacy standard applicable to protected health information (PHI), said contracting parties comprising (1) “covered entities” receiving data of customers and creating, recording, using, and disclosing PHI data of such customers in the ordinary course of business, and (2) “business associates” requiring the use of said PHI data, said method comprising the steps of:
(a) assigning digital identities to the contracting parties;
(b) providing a multilateral Master Business Associate Contract (MBAC) template having non-negotiable terms requiring observation of said privacy standard with respect to said PHI data of a customer;
(c) providing a self-certification standard affidavit template for contracting parties to certify adherence to said privacy standard as self-certified covered entities or as self-certified business associates by electronic signature so as to achieve self-certification;
(d) storing affidavits corresponding to said template in a separate self-certification database;
(e) providing an electronic interface accessible to said digital identities, said electronic interface being selectively connectable to the self-certification database to facilitate negotiating and entering binding multilateral contractual agreements among at least one of said self-certified covered entities and a plurality of said self-certified business associates pursuant to the terms of said affidavits and said MBAC template; and
(f) storing said multilateral contractual agreements in an MBAC database.

224. The method according to claim 223, wherein said electronic interface includes interactive means for negotiating said additional terms with respect to use or disclosure of said PHI data.

225. The method according to claim 223, wherein said interactive means includes means for a covered entity to offer and for a business associate to accept said non-negotiable terms in the MBAC.

226. The method according to claim 223 including the additional step of: accessing a selected multilateral contractual agreement in said MBAC database for permission to disclose selected PHI data to a selected self-certified business associate.

227. The method according to claim 223, wherein said electronic interface comprises the internet.

228. Method for creating and managing contractual relationships among interacting parties under a privacy standard, said interacting parties comprising (1) “covered entities” and (2) “business associates” between which private information is exchanged, said method comprising the steps of:
issuing digital certificates to the interacting parties;
providing community rules having a minimum standard based on said privacy standard requiring compliance of said privacy standard with respect to said private information;
providing an electronic interface accessible to said interacting parties to facilitate negotiating and entering binding agreements among at least one of said covered entities and a plurality of said business associates pursuant to the terms of said community rules; and
storing said binding agreements in a database.

229. The method according to claim 228, further comprising the step of providing certificates of compliance certifying that said interacting parties comply with said community rules.

230. The method according to claim 228, wherein said electronic interface facilitates negotiating additional requirements with respect to use or disclosure of said private information.

231. Method for creating and managing contractual relationships among interacting parties under a privacy standard, said interacting parties comprising (1) “covered entities” and (2) “business associates” between which private information is exchanged, said method comprising the steps of:
issuing digital certificates to the interacting parties;
providing community rules having a minimum standard based on said privacy standard requiring compliance of said privacy standard with respect to said private information;
providing certificates of compliance certifying that said interacting parties comply with said community rules;
providing an electronic interface accessible to said interacting parties to facilitate negotiating and entering binding agreements among at least one of said covered entities and a plurality of said business associates pursuant to the terms of said community rules; and
storing said binding agreements in a database.

232. The method according to claim 231, wherein said step of providing certificates of compliance comprises the steps of:
validating said certificate of compliance; and
storing said certificate of compliance in said database.

233. The method according to claim 231, wherein said electronic interface facilitates negotiating additional requirements with respect to use or disclosure of said private information.

234. The method according to claim 231, wherein said electronic interface facilitates a covered entity to offer and a business associate to accept said community rules having said minimum standard.

235. The method according to claim 231 further comprising the step of querying a target member for permission to disclose selected private information to said target member.

236. The method according to claim 231, wherein said electronic interface comprises the internet.

237. Method for creating and managing contractual relationships among interacting parties under a privacy standard applicable to protected health information (PHI), said interacting parties comprising (1) “covered entities” and (2) “business associates” between which private information is exchanged, said method comprising the steps of:
issuing digital certificates to the interacting parties;
providing community rules having a minimum standard based on said privacy standard requiring compliance of said privacy standard with respect to said PHI;
providing an electronic interface accessible to said interacting parties to facilitate negotiating and entering binding agreements among at least one of said covered entities and a plurality of said business associates pursuant to the terms of said community rules;
providing an agreement for said interacting parties to certify adherence to said privacy standard by electronic signature; and
storing said agreement in a database.

238. The method according to claim 237, wherein said electronic interface facilitates negotiating additional requirements with respect to use or disclosure of said PHI.

239. The method according to claim 237, wherein said electronic interface facilitates a covered entity to offer and a business associate to accept said community rules having said minimum standard.

240. The method according to claim 237, further comprising the step of querying a target member for permission to disclose selected PHI to said target member.

241. The method according to claim 237, wherein said electronic interface comprises the internet.
